(19) United States
(12) Patent Application Publication
(10) Pub. No.: US 2008/0187262 A1
(43) Pub. Date: Aug. 7, 2008

(54) Sealed Radial Rolling Bearing, In Particular Wheel Bearing For a Motor Vehicle

(75) Inventors: Peter Niebling, Bad Kissingen (DE); Ernst Masur, Grettstadt (DE); Hartwig Waldert, Adelsdorf (DE); Georg Schoener, Poppenhausen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/913,504

(22) PCT Filed: Apr. 28, 2006
(86) PCT No.: PCT/DE2006/000742

§ 371 Date: Nov. 7, 2007

(30) Foreign Application Priority Data
May 3, 2005 (DE) 10 2005 020 653.0

(51) Int. Cl. F16C 33/78

(52) U.S. Cl. 384/477

(57) ABSTRACT

The invention relates to a sealed radial rolling bearing, in particular a wheel bearing for a motor vehicle, which substantially comprises an outer bearing ring and an inner bearing ring and a plurality of rolling bodies which roll between the bearing rings and are held with uniform spacing relative to one another by means of a bearing cage. Here, in each case one radially arranged sealing element extends between the bearing rings at each side at a distance axially from the rolling bodies, said sealing element having one or more sealing lips which are connected to the outer bearing ring and some into contact with a centrifugal ring which is connected by means of a press fit to the inner bearing ring. According to the invention, the centrifugal ring of the sealing element is composed of a simple cold-formable steel sheet and has a galvanic corrosion prevention coating with zinc-containing constituents, the cathodic protective action of which can prevent both rust infiltration at the press fit between the centrifugal ring and the inner bearing ring and the onset of corrosion in the region of contact between the sealing lips and the centrifugal ring.

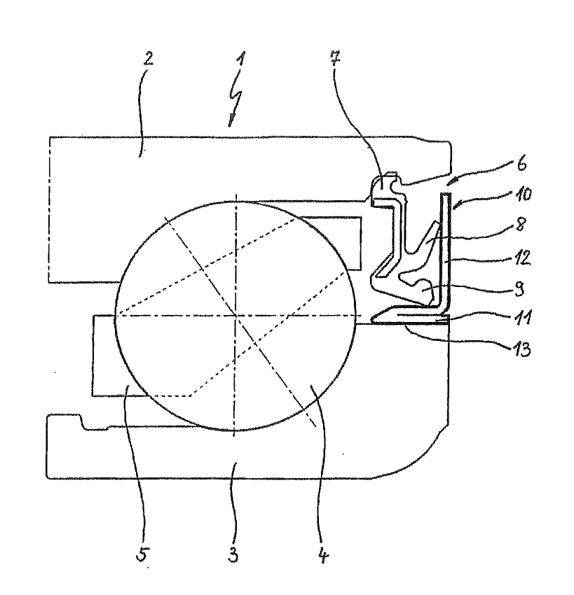

### FIELD OF THE INVENTION

The invention relates to a sealed radial rolling bearing according to the features of the preamble of patent claim 1, and said invention can be particularly advantageously realized in a wheel bearing of a motor vehicle.

### BACKGROUND OF THE INVENTION

A person skilled in the art of rolling bearing technology is generally familiar with a plurality of sealed radial rolling bearings which are composed substantially of an outer bearing ring and an inner bearing ring and of a plurality of rolling bodies which roll between the bearing rings and which are held at regular intervals with respect to one another by means of a bearing cage. Said radial rolling bearings, in particular where used as wheel bearings on motor vehicles, have, in order to provide sealing against moisture and dirt, one radially arranged sealing element between the bearing rings at both sides axially spaced apart from the rolling bodies, which sealing element has at least one sealing lip which is connected to the outer bearing ring and which comes into contact with a spinning ring which is connected to the inner bearing ring by means of a press fit.

DE 103 35 713 A1 for example discloses a generic radial rolling bearing of said type in which the radial sealing element which is axially spaced apart from the rolling bodies is composed of an elastomeric sealing ring which is stiffened by means of an integrally vulcanized sheet metal ring, which elastomeric sealing ring is fastened with one end of its profile cross section in a groove on the stationary outer bearing ring and has, at the other end of its profile cross section, three sealing lips which are arranged radially one above the other. Said elastomeric sealing ring is assigned a spinning ring which delimits the sealing element axially to the outside and is L-shaped in profile cross section, which spinning ring is connected, by means of its profile limb which is aligned axially inward or toward the rolling bodies, to the inner ring of the radial rolling bearing by means of a press fit. The central one of the three sealing lips of the elastomeric sealing ring lies on said axial profile limb, while the radially outer sealing lip comes into contact with the radial profile limb of the spinning ring and the radially inner sealing lip comes into contact with the inner bearing ring.

A disadvantage of said bearing seals, which are also referred to as cassette seals, is however that the spinning ring of the seal must be produced from a rust-resistant steel sheet in order to avoid corrosion, so that this results in relatively high material costs and therefore increases the production costs of the bearing. In addition, rust-resistant steel sheets, as a result of their special alloy constituents, can generally be formed in a non-cutting process only with difficulty or to a limited extent, so that said rust-resistant steel sheets are suitable only for forming simple cross-sectional geometries. In addition, it has been shown in practice that, as a result of production inaccuracies in the non-cutting shaping of the spinning ring, and as a result of tolerances at the outer diameter of the inner bearing ring, gaps can form at the seat point of the spinning ring on the inner bearing ring, as a result of the capillary action of which an infiltration of moisture into said seat point becomes possible. Since a simple rolling bearing steel is usually used for the inner bearing ring, it is therefore possible, despite the formation of the spinning ring from a rust-resistant steel sheet, for rust infiltration to occur at the seat point, which, with continued operating duration, leads to water passing into the bearing space, and is responsible for early failure of the bearing.

A simple measure for avoiding the infiltration of moisture at the seat point of the spinning ring on the inner bearing ring would therefore be to seal the seat point by means of suitable measures. Such a measure is for example known from DE 38 06 928 A1, in which it is proposed to provide that face of the axial limb of the L-shaped spinning ring which is situated opposite the inner bearing ring of the bearing, in the non-assembled state, with a thin elastic covering which is stripped off during the assembly of the spinning ring in such a way that said elastic covering is piled up in an encircling groove in the outer lateral surface of the inner bearing ring.

Such a sealing of the seat point of the spinning ring on the inner bearing ring is however very expensive and has not been proven in practice because, like before, contact corrosion is possible in the region of the seat point which is freed of the elastic covering, as a result of which it is likewise possible for rust infiltration at the seat point to occur, and for water to pass into the bearing space with continued operating duration. In addition, the peripheral groove, which is provided for the piling up of the stripped-off elastic covering, in the outer lateral surface of the inner bearing ring has been proven to be disadvantageous because this results in the seat face of the spinning ring on the inner bearing ring becoming smaller, and therefore in the retaining force thereof being adversely affected.

Another possibility for avoiding the infiltration of moisture at the seat point of the spinning ring on the inner bearing ring is also known from DE 38 22 816 A1. In this solution, the axial limb of the L-shaped spinning ring has, at the free end, a projection which, after its assembly, latches into a groove in a shaft or in the outer lateral surface of an inner bearing ring. A sealing lacquer is previously applied to the adjoining cylindrical seat face of the spinning ring, which sealing lacquer is protected by the above-mentioned projection during assembly because it does not touch the opposing face. Only when the projection of the sheet metal part latches into the groove does the diameter of the cylindrical seat face change, so that the sealing lacquer comes into contact with the opposing surface, and any gap at this point is hermetically sealed.

A measure of said type has however also not been proven in practice since, for it to be realized, the axial limb of the L-shaped spinning ring must be provided with an additional bend for the projection, for which additional tools and method steps in the production of said bend are required, and which therefore entails increased production costs for the bearing. It has additionally been proven that the protective action of said projection for the sealing lacquer which is applied to the adjoining seat face of the spinning ring is not provided one hundred per cent, since grazes and cracks in the sealing lacquer occurred during the assembly of the spinning ring, which in turn led to contact corrosion and to leaks at the seat point, with the already-described disadvantageous effects.

### OBJECT OF THE INVENTION

Proceeding from the described disadvantages of the solutions of the known prior art, the invention is therefore based on the object of designing a sealed radial rolling bearing, in particular wheel bearing of a motor vehicle, whose seal has a spinning ring which can be easily shaped in a non-cutting process and is composed of a cost-effective material, and in which contact corrosion and rust infiltration on the spinning ring at its press fit with respect to the inner bearing ring are excluded.

### DESCRIPTION OF THE INVENTION

According to the invention, said object is achieved in the case of a sealed radial rolling bearing according to the preamble of claim 1 in such a way that the spinning ring of the sealing element is composed of a simple cold-formable steel sheet and has a galvanic corrosion prevention coating with zinc-containing constituents, by means of the cathodic protective action of which both rust infiltration on the spinning ring at its press fit with respect to the inner bearing ring, and also corrosion onsets in the region of contact of the sealing element against the spinning ring, can be avoided.

The invention is therefore based on the utilization of the effect, which is known per se, of the cathodic protective action which always occurs if the two metals zinc and steel are connected to one another in an electrically conductive mariner by means of electrolytes such as relative air humidity, rain water and the like. Said effect is based on the fact that zinc is situated lower in the electrochemical series of metals than steel, and consists substantially in the fact that, as a result of the electrolyte, a galvanic element is formed, by means of which a voltage difference is generated between the coating of the spinning ring and the inner bearing ring. The “less noble” metal zinc dissolves as a sacrificial anode, that is to say electrons pass from the zinc in the coating to the steel of the bearing ring, so that the “more noble” steel is protected against corrosion by electrochemical means.

Preferred embodiments and refinements of the radial rolling bearing according to the invention are described in the subclaims.

It is accordingly provided as claimed in claims 2, 3 and 4 that the corrosion prevention coating of the spinning ring can alternatively be produced from a zinc-iron alloy, a zinc-nickel alloy or a zinc-cobalt alloy. In order to protect the main alloy constituent zinc from corrosion, in the case of the zinc-iron alloy, the zinc has approximately 1% iron “added by alloying”, while in the case of the zinc-nickel alloy, approximately 10% nickel, and in the case of the zinc-cobalt alloy, also approximately 1% cobalt, are embedded into the zinc in the manner of an alloy.

As one embodiment of the radial rolling bearing according to the invention, it is finally also proposed by claim 5 that the corrosion prevention coating of the spinning ring has a layer thickness of 0.5 μm to 3.0 μm. Said layer thicknesses vary within the order of magnitude of the surface roughness on rolling bearing components, and have the advantage that the galvanic layer is incorporated entirely into the roughness profile of the surface of the spinning ring and can therefore have no adverse effect on its tolerances. It is likewise possible on account of the lower layer thicknesses to reduce the environmental impact.

The sealed radial rolling bearing according to the invention therefore has the advantage over the radial rolling bearings with cassette seals that are known from the prior art, that a simple steel sheet can be used as a base material for the spinning ring, which steel sheet is not only cost-effective but can also be machined and shaped in a non-cutting process in a simple manner and is therefore also suitable for producing complex cross-sectional geometries. The coating of the spinning ring with a zinc-containing corrosion prevention layer has the additional advantage that, as a result of the cathodic protective action, both the spinning ring itself and also its press fit with respect to the inner bearing ring of the radial rolling bearing are protected long-term against corrosion and rust infiltration, so that an infiltration of water into the bearing space and an early failure of the bearing are excluded. Also in the region of the sealing lips, in which region visually blank surfaces are generated as a result of the run-in into the extremely thin coating, the formation of rust in the region of contact with moisture is avoided long-term on account of the remote action of the cathodic protection. Despite the low layer thicknesses of the corrosion prevention layer, a high level of rust prevention is therefore achieved with virtual dimensional neutrality and cost-effective production of the coated parts.

### BRIEF DESCRIPTION OF THE DRAWINGS

One preferred embodiment of the sealed radial rolling bearing according to the invention is explained in more detail below with reference to the appended drawing. The single FIGURE shows a partial view of a cross section through a radial rolling bearing according to the invention with a cassette seal.

### DETAILED DESCRIPTION OF THE DRAWINGS

The drawing clearly shows a sealed radial rolling bearing 1 which is embodied as a wheel bearing of a motor vehicle and which is composed substantially of an outer bearing ring 2 and an inner bearing ring 3 and of a plurality of rolling bodies which roll between the bearing rings 2, 3 and which are held at regular intervals with respect to one another by means of a bearing cage 5. The drawing also shows that one radially arranged sealing element 6 extends between the bearing rings 2, 3 at both sides axially spaced apart from the rolling bodies 4, which sealing element 6 is composed in each case of an elastomeric sealing ring 7 which is stiffened by means of an integrally vulcanized sheet metal ring (not described in any more detail). It can be clearly seen that the elastomeric sealing ring 7 is fastened with one end of its profile cross section in a groove (likewise not described in any more detail) on the stationary outer bearing ring 2, while having, at the other end of its profile cross section, two sealing lips 8, 9 which are arranged radially one above the other. Said elastomeric sealing ring 7 is assigned a spinning ring 10 which delimits the sealing element 6 axially to the outside and is L-shaped in cross section, which spinning ring 10 is connected, by means of its profile limb 11 which is aligned axially inward or toward the rolling bodies, to the inner bearing ring 3 of the radial rolling bearing 1 by means of a press fit. The radially inner sealing lip 9 of the elastomeric sealing ring 7 lies on said axial profile limb 11, while the radially outer sealing lip 8 comes into contact with the radial profile limb 12 of the spinning ring 10.

It can additionally be seen from the drawing, merely by way of indication, that the spinning ring 10 of the sealing element 6 according to the invention is composed of a sample cold-formable steel sheet and has a galvanic corrosion prevention coating 13 with zinc-containing constituents, by means of the cathodic protective action of which both rust infiltration on the spinning ring 10 at its press fit with respect to the inner bearing ring 3, and also corrosion onsets in the region of contact of the sealing lips 8, 9 against the profile limbs 11, 12 of the spinning ring 10, can be avoided. The corrosion prevention coating 13 of the spinning ring 10 is produced from a zinc-iron alloy and has a layer thickness of 0.5 μm to 3.0 μm.

### LIST OF REFERENCE SYMBOLS

1 Radial rolling bearing
2 Outer bearing ring
3 Inner bearing ring
4 Rolling bodies
5 Bearing cage
6 Sealing element
7 Elastomeric sealing ring
8 Sealing lip
9 Sealing lip
10 Spinning ring
11 Axial profile limb
12 Radial profile limb
13 Corrosion prevention coating

1. A sealed radial rolling bearing (1), in particular wheel bearing of a motor vehicle, which radial rolling bearing (1) is composed substantially of an outer bearing ring (2) and an inner bearing ring (3) and of a plurality of rolling bodies (4) which roll between the bearing rings (2, 3) and which are held at regular intervals with respect to one another by means of a bearing cage (5), wherein one radially arranged sealing element (6) extends between the bearing rings (2, 3) at both sides axially spaced apart from the rolling bodies (4), which sealing element (6) has one or more sealing lips (8, 9) which are connected to the outer bearing ring (2) and which come into contact with a spinning ring (10) which is connected to the inner bearing ring (3) by means of a press fit, characterized in that the spinning ring (10) of the sealing element (6) is composed of a simple cold-formable steel sheet and has a galvanic corrosion prevention coating (13) with zinc-containing constituents, by means of the cathodic protective action of which both rust infiltration on the spinning ring (10) at its press fit with respect to the inner bearing ring (3), and also corrosion onsets in the region of contact of the sealing lips (8, 9) against the spinning ring (10), can be avoided.

2. The sealed radial rolling bearing as claimed in claim 1, characterized in that the corrosion prevention coating (13) of the spinning ring (10) is produced from a zinc-iron alloy.

3. The sealed radial rolling bearing as claimed in claim 1, characterized in that the corrosion prevention coating (13) of the spinning ring (10) is produced from a zinc-nickel alloy.

4. The sealed radial rolling bearing as claimed in claim 1, characterized in that the corrosion prevention coating (13) of the spinning ring (10) is produced from a zinc-cobalt alloy.

5. The sealed radial rolling bearing as claimed in one of claims 2 to 4, characterized in that the corrosion prevention coating (13) of the spinning ring (10) has a layer thickness of 0.5 μm to 3.0 μm.
